(19) United States
(12) Patent Application Publication
(10) Pub. No.: US 2023/0327796 A1
(43) Pub. Date: Oct. 12, 2023

(54) Microphone Jammer

(71) Applicant: Pozio Privacy Innovations Inc., Vancouver (CA)

(72) Inventors: David John NICKEL, Vancouver (CA); Bruce John CLELAND, Vancouver (CA); Evan Bradley Osborne MCDOUGALL, Vancouver (CA); Kerry CHIN, Vancouver (CA); Shawn STEVENSON, Vancouver (CA); Morgan GILBERT, Vancouver (CA)

(21) Appl. No.: 18/023,262

(22) PCT Filed: Jun. 2, 2021
(86) PCT No.: PCT/CA2021/050758

§ 371 Date: Feb. 24, 2023

Related U.S. Application Data
(60) Provisional application No. 63/157,623, filed on Mar. 5, 2021.
(60) Provisional application No. 63/116,951, filed on Nov. 23, 2020.
(60) Provisional application No. 63/070,745, filed on Aug. 26, 2020.

(51) Int. Cl. H04K 3/00

(52) U.S. Cl. CPC H04K 3/43; H04K 3/41; H04K 2203/12

(57) ABSTRACT

A microphone jammer includes an ultrasonic transducer for emitting an ultrasonic jamming signal to jam a microphone of an external electronic device. The apparatus includes a sound chamber that is shaped to direct the ultrasonic jamming signal towards an area for placement of an external electronic device that includes the microphone. The apparatus may include a base and a top portion connected to the base, with the ultrasonic transducer being in the top portion and the sound chamber being shaped to direct the ultrasonic jamming signal towards the base.

### TECHNICAL FIELD

The present disclosure is directed at a microphone jammer.

### BACKGROUND

Many electronic devices include a microphone for receiving input. For some such devices, the microphone may be always receiving sounds from the environment such that a processor within the electronic device may continuously scan for commands. Accordingly, this allows users to provide voice commands to the electronic devices at any time and receive a response or have the electronic device carry out an action.

More recently, the proliferation of smart speakers has taken advantage of such microphones to be always on and listening to the environment. The ability to record sounds from an environment may provide various conveniences such as being able to control other devices. For example, a smart speaker may be able to control the lighting in a room or operate the climate control system. By continuously listening for voice commands, the smart speaker may recognize a command at any time using voice recognition software that is often executed in the cloud. In addition to recognizing commands, microphones may be used to record voices and speech to collect data which may be used to further train voice recognition engines to improve the accuracy of the voice recognition.

### SUMMARY

In accordance with an aspect, an apparatus is provided. The apparatus includes a transducer to emit a jamming signal. Furthermore, the apparatus includes a microphone to monitor for a voice command. In addition, the apparatus includes a memory storage unit to store a model of the voice command. The apparatus also includes a controller to control the transducer in response to a detection of the voice command. The transducer is to toggle between an active state and an inactive state. The transducer emits the jamming signal in the active state.

The controller may automatically activate the transducer after a period of time.

The apparatus may further include a manual input device to receive user input. The manual input device may be to lock the transducer in one of the active state or the inactive state. The transducer may be locked in the active or inactive state for a predetermined period of time or until some type of situational criteria is satisfied (e.g., until receiving a voice command that the transducer is to be unlocked).

According to another aspect, there is provided an apparatus comprising: a base; and a top portion connected to the base, the top portion comprising an ultrasonic transducer configured to emit an ultrasonic jamming signal and a sound chamber shaped to direct the ultrasonic jamming signal towards the base.

The top portion may be toroidal in shape.

The sound chamber may circumscribe a hole in the top portion.

An interior of the sound chamber may comprise one or more flat sides positioned to direct the ultrasonic jamming signal towards the base.

A cross section of the sound chamber may comprise a triangular portion on a trapezoidal portion.

The triangular portion may be shaped as an isosceles triangle and the trapezoidal portion may be shaped as an isosceles trapezoid.

The ultrasonic transducer may be located in a side of the sound chamber.

The top portion may comprise a top side and an underside, the underside may comprise the sound chamber and the transducer, and the top side may comprise one or more microphones for receiving an audio command.

The apparatus may further comprise a controller communicatively coupled to the one or more microphones and the transducer, and the controller may be configured to: cause the ultrasonic transducer to emit the ultrasonic jamming signal; detect a spoken pause command received via the one or more microphones; suspend emission of the jamming signal for a predetermined time period in response to the spoken pause command; and after expiry of the predetermined time period, cause the ultrasonic transducer to resume emitting the ultrasonic jamming signal.

According to another aspect, there is provided an apparatus comprising: a sound chamber; and an ultrasonic transducer configured to emit an ultrasonic jamming signal and positioned to direct the ultrasonic jamming signal to the sound chamber, wherein the sound chamber is shaped to direct the ultrasonic jamming signal towards an area for placement of an external electronic device comprising a microphone.

An interior of the sound chamber may comprise one or more flat sides positioned to direct the ultrasonic jamming signal towards the area for placement of the external electronic device.

A cross section of the sound chamber may comprise a triangular portion on a trapezoidal portion.

The triangular portion may resemble an isosceles triangle and the trapezoidal portion may resemble an isosceles trapezoid.

The ultrasonic transducer may be located in a side of the sound chamber.

The apparatus may further comprise a controller communicatively coupled to the transducer and configured to cause the transducer to emit the jamming signal, wherein the controller is configured to cause the jamming signal to comprise a tone at a first frequency and a bandlimited signal comprising frequency components spanning a frequency range.

The first frequency may be within the frequency range.

The first frequency may be approximately 39.5 kHz.

The frequency range of the bandlimited signal may be from approximately 33 kHz to approximately 48 kHz.

The bandlimited signal may be a bandlimited white noise signal.

The bandlimited signal may be a bandlimited Gaussian noise signal.

The apparatus may further comprise one or more lights, and the controller may comprise: a main processor configured to cause the transducer to emit the jamming signal; and a user interface processor configured to control illumination of the one or more lights.

The apparatus may further comprise: a base; and a top portion connected to the base, the top portion comprising the ultrasonic transducer and the sound chamber, wherein the sound chamber is shaped to direct the ultrasonic jamming signal towards the base.

The sound chamber may circumscribe a hole in the top portion.

The ultrasonic transducer may be positioned to emit the ultrasonic jamming signal in a direction parallel to the base.

The top portion may comprise a top side and an underside, wherein the underside comprises the sound chamber and the transducer, and wherein the top side comprises one or more microphones for receiving an audio command.

The apparatus may further comprise a controller communicatively coupled to the one or more microphones and the transducer, the controller configured to: cause the ultrasonic transducer to emit the ultrasonic jamming signal; detect a spoken pause command received via the one or more microphones; suspend emission of the jamming signal for a predetermined time period in response to the spoken pause command; and after expiry of the predetermined time period, cause the ultrasonic transducer to resume emitting the ultrasonic jamming signal.

The base may comprise a seat positioned under the top portion, and the seat may comprise an inductive charger.

According to another aspect, there is provided an apparatus comprising: an ultrasonic transducer; a controller communicatively coupled to the ultrasonic transducer, the controller configured to cause the transducer to emit the jamming signal, wherein the controller is configured to cause the jamming signal to comprise a tone at a first frequency and a bandlimited signal comprising frequency components spanning a frequency range, wherein the first frequency is approximately 39.5 kHz.

According to another aspect, there is provided an apparatus comprising: an ultrasonic transducer; a microphone; and a controller communicatively coupled to the ultrasonic transducer and the microphone, the controller configured to: cause the ultrasonic transducer to emit the ultrasonic jamming signal; detect a spoken pause command received via the one or more microphones; suspend emission of the jamming signal for a predetermined time period in response to the spoken pause command; and after expiry of the predetermined time period, cause the ultrasonic transducer to resume emitting the ultrasonic jamming signal.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Reference will now be made, by way of example only, to the accompanying drawings in which:

FIG. 1 is a block diagram of an example apparatus to jam a microphone from monitoring sounds in an environment;

FIGS. 2A and 2B are graphs that illustrate the frequency responses of example high-pass filters that may comprise part of an example of an apparatus to jam a microphone from monitoring sounds in an environment;

FIG. 3 is a photo of an example of an apparatus to jam a microphone from monitoring sounds in an environment;

FIG. 4 is a photo of another example of an apparatus to jam a microphone from monitoring sounds in an environment;

FIG. 5 is a photo of an example of an apparatus to jam a microphone from monitoring sounds in an environment;

FIG. 6 is a block diagram of an example apparatus to jam a microphone from monitoring sounds in an environment;

FIG. 7 is a perspective view of an example apparatus to jam a microphone from monitoring sounds in an environment,

FIG. 8 is a top plan view of a printed circuit board comprising part of a base of the apparatus of FIG. 7;

FIG. 9 is a top plan view of a printed circuit board comprising part of a top portion of the apparatus of FIG. 7;

FIG. 10 is a bottom perspective view of the top portion of the apparatus of FIG. 7;

FIG. 11 is a top plan view of the top portion of the apparatus of FIG. 7;

FIG. 12 is a bottom plan view of the top portion of the apparatus of FIG. 7;

FIG. 13 is a sectional view of the top portion of the apparatus of FIG. 7 taken along line 13-13 of FIG. 7; and

FIG. 14 is sectional view of the top portion of the apparatus of FIG. 7 taken along line 14-14 of FIG. 7.

### DETAILED DESCRIPTION

Electronic devices, such as mobile phones, tablets, laptops, smart speakers, and digital assistants may have microphones that are powered on and continuously monitoring sounds within range of the microphone. This allows for the electronic devices to receive and recognize input and operate accordingly. These electronic devices may or may not be connected to the internet. For example, the electronic device may be configured to monitor for voice commands from a user to either operate the electronic device itself or to operate other devices connected to the electronic device in a closed network or over the internet. More specifically, smart speakers are becoming more common in various places, such as the home. The smart speakers may be configured to monitor sounds within a room and to recognize the voice of a user. The smart speaker may also distinguish conversation from the user, such as to another person or device, from a voice command intended for the smart speaker.

In addition to monitoring an environment for voice commands, the electronic devices may monitor an environment for other noises that may be a triggering event. For example, an electronic device, such as a smart switch may include a microphone to listen for sounds. In operation, the smart switch may assume a room is empty if no sounds are detected. Accordingly the smart switch may power off various devices such as lights or ventilation. Upon the detection of a sound, it may be assumed that the room is occupied again triggering the switch to power on devices that were previously powered off.

Furthermore, since the electronic devices often operate on voice recognition software that relies on machine learning, microphones may be used to collect speech and other sounds to further train the voice recognition engine. Although these activities may not be carried out, the hardware is capable of carrying out data collection for various purposes. In some cases, conversations and other sounds may be recorded and analyzed by a third party to generate data for marketing or other purposes. Since the hardware capability is available to direct recorded sounds to the cloud, the possibility for a malicious harvesting of information or spying also exists by unknown parties who may gain unauthorized access to the microphone on the electronic device.

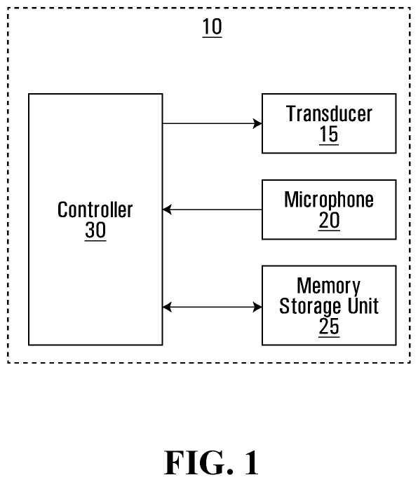

Referring to FIG. 1, an example of an apparatus to jam a microphone from monitoring sounds in an environment is generally shown at 10. The apparatus 10 may include additional components, such as various input and output devices to interact with a user to control the apparatus 10. It is to be appreciated by a person of skill with the benefit of this description that the apparatus 10 may typically exclude other interfaces that provide for connectivity. Accordingly, the apparatus 10 may be completely disconnected from other networks such that it cannot be remotely controlled or hacked by an external party via the internet. In the present example, the apparatus 10 includes a transducer 15, a microphone 20, a memory storage unit 25, and a controller 30.

The transducer 15 is to emit a jamming signal. It is to be appreciated that the transducer 15 is not particularly limited and may be a device capable of emitting a signal to jam a microphone. In particular, the transducer 15 is to emit sound waves that may reach a microphone of an external electronic device. The jamming signal may have a frequency of about 39.5 kHz, which is typically beyond the audible range of the human ear. Accordingly, the transducer 15 may be operated in a room without any significantly noticeable sound to human occupants in the room.

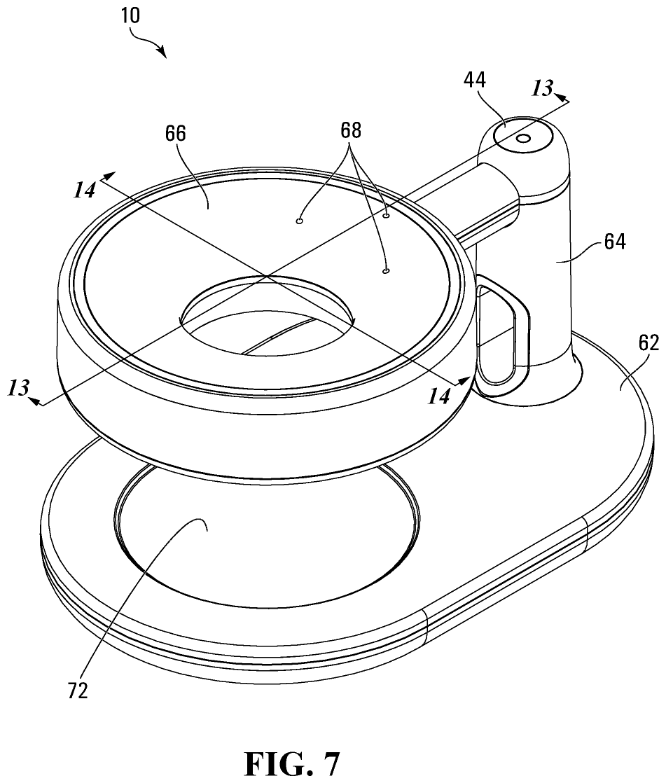

The manner by which the transducer 15 jams the microphone of an external electronic device is not particularly limited. In the present example, the transducer 15 may generate a waveform based on an electrical signal received from the controller 30. The waveform is not limited and may be custom designed for a microphone of specific external electronic device. It is to be appreciated by a person of skill that different microphones on different external electronic devices may respond to jamming signals with different waveforms. Accordingly, the transducer 15 may be configured to generate sound signals having different waveforms for different external electronic devices to be jammed. The signal generated by the transducer 15 may be amplified using an amplifier to increase the efficiency of the jamming. In the present example, a high-end, consumer hi-fi home theater amplifier that is able to amplify signals up to about 100 kHz is used, but in other examples, amplifiers may be configured to amplify smaller ranges of frequencies. For example, as in the embodiments of FIGS. 7-14 discussed below, an integrated circuit may be used instead of a consumer amplifier.

An example of a signal that may be used to jam a microphone is a combination of a tone at about 39.5 kHz mixed with shaped (filtered), band limited noise in the range of about 39 kHz to about 41 kHz. The tone may be generated using a 384 element lookup table having one cycle of a sine wave for efficiency and to reduce the computational resources used to generate the tone. The signal is then generated by filtering a sequence of samples generated using a random number function. Before filtering, the sample values may be distributed with approximately a uniform distribution between the values −32768 and 32767. A high-pass filter may be used to reduce the power of the signal in lower frequencies. The high-pass filter may have a finite impulse response with coefficients h=[0.5, −0.5].

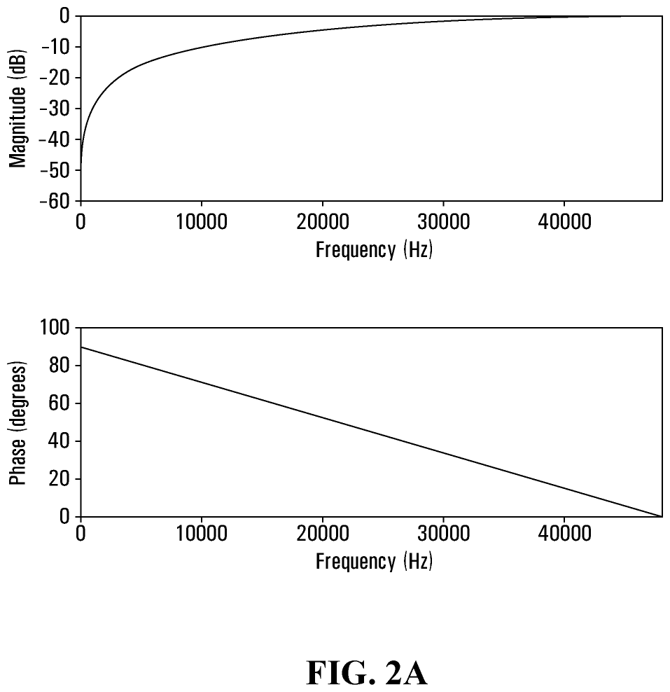

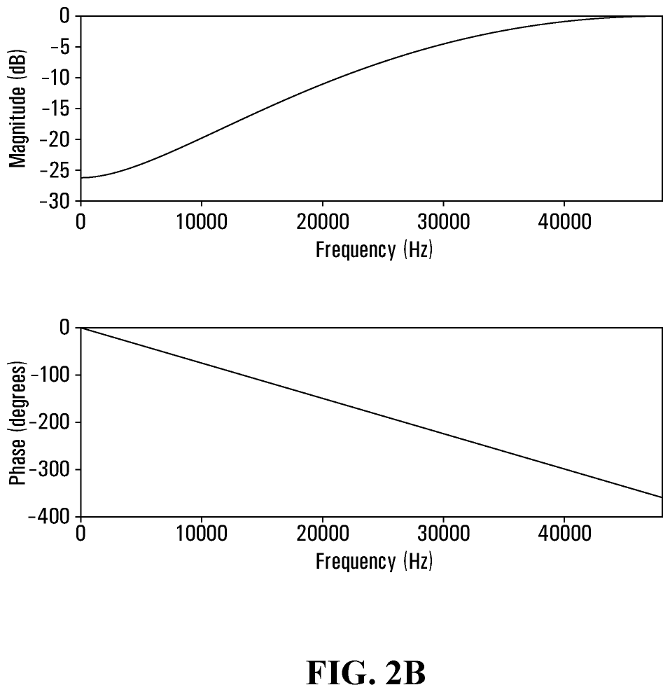

Referring to FIG. 2A, the frequency response of the filter of the present example is shown. It is to be appreciated by a person of skill with the benefit of this description that the use of the high-pass filter decreases the volume of audible sounds from the transducer 15. In different embodiments, the filter may have different characteristics. For example, in different embodiments the filter may have the frequency response as depicted in FIG. 2B, which is discussed further below in respect of the embodiment of FIGS. 7-14. After filtering the signal may be amplified to about 3.4 Vᵣₘₛ at the input to the transducer 15.

Referring again to FIG. 1, the microphone 20 is to monitor an environment for a voice command. The manner by which the microphone 20 monitors for a voice command is not limited and may involve an application or running on the controller 30 to detect known commands. It is to be appreciated by a person of skill that since the apparatus 10 may not have any connection to a network, the controller 30 is to carry out all voice recognition functionality locally to detect and process a voice command.

In operation, the microphone 20 operates as another transducer to convert the sound waves into a digital signal for the controller 30 to process. The controller 30 may include a voice recognition engine or a natural language processing engine to detect the voice command locally and to carry out a predetermined action. For example, the voice command may be to deactivate the transducer 15 which stops the transducer 15 from emitting the jamming signal. In other examples, the voice command may activate the transducer 15 or carry out other functionality.

Since the transducer 15 emits a jamming signal, the microphone 20 may also be jammed in some examples. To reduce the likelihood of jamming the microphone 20, the transducer 15 may be configured to emit sound signals away from the microphone 20. In other examples, the microphone 20 may be configured to be nonresponsive to frequencies at which the transducer 15 emits sounds. In another example, the microphone 20 may include filters to block the jamming signal from the transducer 15.

The memory storage unit 25 is to store one or more models of the voice commands in a record. In examples where the apparatus 10 is to accept multiple voice commands with different functionality, the voice command models may be stored in a database having a plurality of records. The manner by which the memory storage unit 25 stores the records is not particularly limited. Each record may include a voice command model, such as a model of a wake command, and the associated function, such as deactivating the transducer 15. Multiple models of voice commands may be stored in the memory storage unit 25 without using a database in at least some other embodiments.

Furthermore, the memory storage unit 25 may be a non-transitory machine-readable storage medium such as an electronic, magnetic, optical, or other physical storage device. In the present example, the memory storage unit 25 is a persistent memory. In at least some embodiments, the memory storage unit 25 may also store an operating system that is executable by the controller 30 to provide general functionality to the apparatus 10. For example, the operating system may provide various operations on the apparatus 10 such as monitoring for a voice command, such as a wake word. Examples of operating systems include WINDOWS, MACOS, iOS, ANDROID, LINUX, and UNIX. The memory storage unit 25 may additionally store instructions to operate at the driver level to communicate with other components and peripheral devices of the apparatus 10 such as various LEDS, display screens, touchscreens or sensors.

The controller 30 is to control the transducer 15 in response to input received at the microphone 20. In particular, the controller 30 may be to toggle the transducer 15 between an active state and an inactive state. In the active state, the transducer 15 is to emit the jamming signal as described above. In the present example, the controller 30 may send electrical signals directly to the transducer 15, such as generated waveforms to cause the transducer 15 to emit the jamming signal. In other examples, a separate microcontroller with relatively lower processing power may be used such that the controller 30 may send a control signal to cause the separate microcontroller to operate the transducer 15.

The manner by which the controller 30 operates the transducer 15 is not limited and may be varied depending on user preferences. For example, the controller 30 may continuously send the jamming signal to be emitted to maintain the transducer 15 in the active state. Upon receiving a voice command to toggle the transducer 15 to the inactive state, the controller 30 may automatically re-activate the transducer 15 after a period of time. The period of time is not limited and may be after 10 seconds, 20 seconds, or longer. The period of time may be shorter than 10 seconds as well. In other examples, the controller 30 may monitor via the microphone 20 for further sounds or voice commands intended for the microphone of the external electronic device and re-activate the transducer 15 after no further sounds or voice commands are detected. In further examples, the controller 30 may monitor for a re-activate command instead of automatically re-activating the transducer 15 such that the transducer 15 remains locked in a state until user input is received.

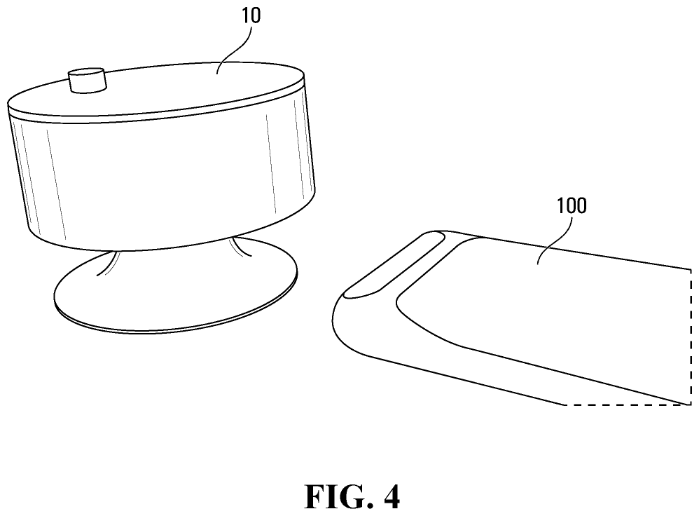

It is to be appreciated by a person of skill with the benefit of this description that variations to the apparatus 10 are contemplated. For example, although the above example discloses using a single transducer 15, it is to be understood that more than one transducer 15 may be used. In addition, physical features may be used to direct the sound signals from the transducer 15 toward the location of the microphone of the external electronic device such as shown in FIG. 4. In FIG. 4, the transducer 15 (not shown) emits the jamming signal downwards towards the apparatus's 10 base, and the jamming signal is reflected towards the microphone of the external electronic device 100. Similarly, additional microphones 20 may be included to monitor for the voice command from different directions.

As another example of a variation, the apparatus 10 may include a manual input device to receive user input and to interact with a user of the apparatus 10. The manual input device is not particularly limited and may be used to control various features of the apparatus 10, such as locking the transducer 15 in one state or the other, adjusting the volume of the transducer 15, adjusting the sensitivity of the microphone 20, as well as other features. The form of the manual input device is not limited and may be a touchscreen in some examples, or may be one or more actuating buttons.

Furthermore, other additional input devices may be added to the apparatus such as light sensors or cameras. In particular, a light sensor or camera may be used to monitor the external electronic device to determine its status. For example, the external electronic device may have an indicator for active listening which suggests a user is providing voice commands. Once the external electronic device stops actively listening for voice commands, the controller 30 may reactivate the transducer 15 to jam any passive listening.

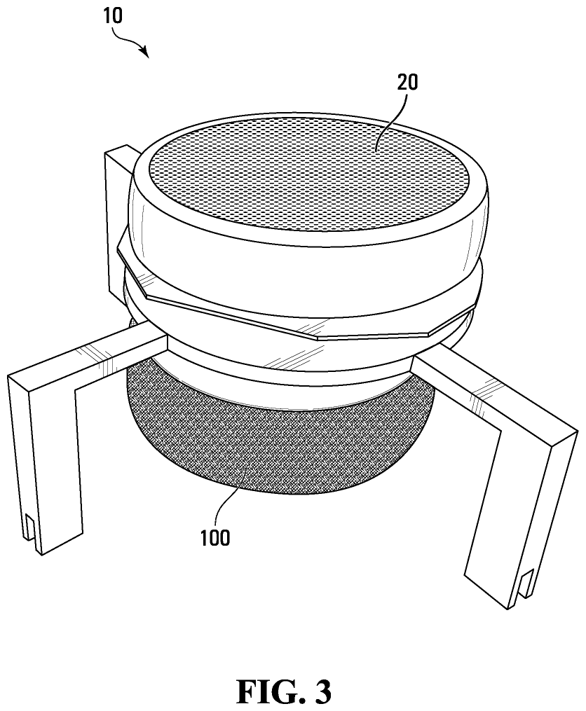

Referring to FIG. 3, an example of the apparatus 10 to jam a microphone of an external electronic device 100 from monitoring sounds in an environment is shown. Like the apparatus 10 of FIG. 1, the apparatus 10 of FIG. 3 includes the transducer 15 (not shown), microphone 20, a memory storage unit (not shown), and a controller (not shown).

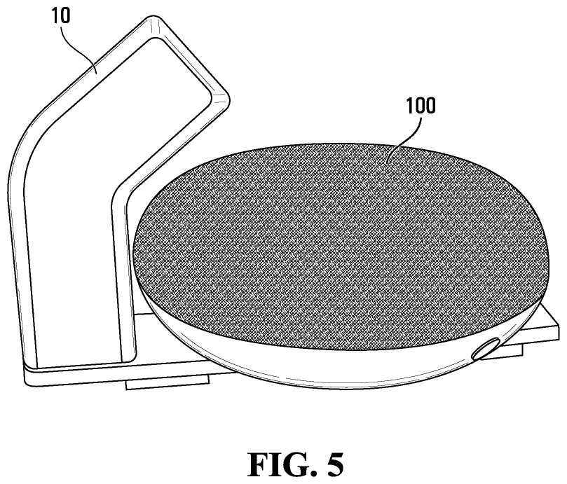

Referring to FIG. 4, another example of an apparatus 10 to jam a microphone of an external electronic device 100 from monitoring sounds in an environment is shown. FIG. 5 also shows another example of the apparatus 10 to jam a microphone of an external electronic device 100 from monitoring sounds in an environment.

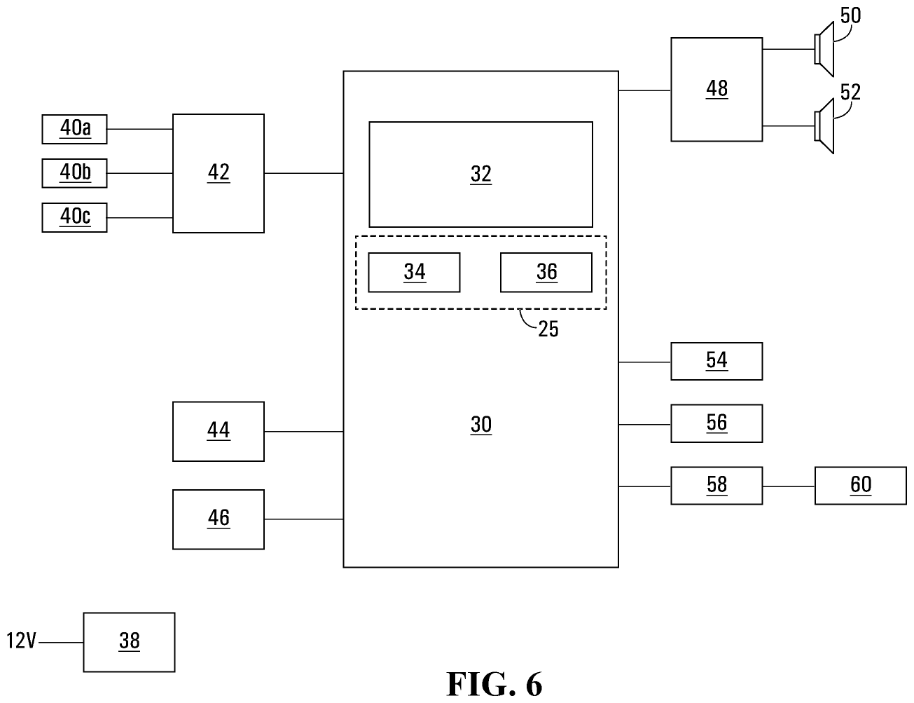

Referring now to FIG. 6, there is shown another example of the apparatus 10 to jam a microphone of an external electronic device 100 from monitoring sounds in an environment. The apparatus 10 of FIG. 6 depicts the controller 30, with the controller 30 comprising a main processor 32, internal flash memory 34, and internal random access memory (RAM) 36, with the flash memory 34 and RAM 36 communicative with the processor 32. Collectively, the flash memory 34 and RAM 36 comprise the memory storage unit 25. The flash memory 34 has encoded thereon computer program code that is executable by the processor 32 and that, when executed by the processor 32, causes the processor 32 to perform the methods described herein, including jamming signal generation and audio detection. An example processor 32 is the ARM Cortex-M7™ processor.

Various components are communicatively coupled to the controller 32. These components comprise a pulse density modulation (PDM) to time domain multiplexed (TDM) converter, which is connected to first through third microphones 40a-c; one or more pushbuttons 44; a debugger/flash programmer 46; an amplifier 48 with digital input (e.g., a class D amplifier) that outputs signals to an ultrasonic transducer 50 and loudspeaker 52; LEDs 54 that form part of the apparatus's 10 user interface; a UART 56 for debugging purposes; and a secondary microcontroller UART 58, which outputs a signal to additional LEDs 60. The controller 30 is powered by power circuitry 38, which receives a 12 V power supply such as from a series of batteries or an AC-to-DC power converter.

In at least the present embodiment, the processor 32 samples inputs and outputs at different rates. For example, the processor 32 may sample inputs from the microphones 40a-c at 16 kHz, and output signals to one or both of the ultrasonic transducer 50 and loudspeaker 52. Also in the present embodiment and as discussed further below, the microphones 40a-c are digital microphones and obtain sound input in parallel; and the ultrasonic transducer 50 has a resonance frequency of approximately 40 kHz. Additionally, while the present embodiment uses a single ultrasonic transducer 50, in at least some other embodiments, multiple ultrasonic transducers 50 may be used.

As discussed above, the ultrasonic jamming performed by the apparatus 10 is performed on the microphone of the external electronic device 100. The microphone output of the external electronic device 100 can be modeled as an amplified input signal plus a non-linear component:

Y=Ax+Bx² (1)

where Y is the output electrical signal, x is the input acoustic signal, and A and B are gain factors.

If the input is comprised of two tones, then the non-linear term produces tone signals that are related to the sum and difference of the two tone frequencies. Assuming two ultrasonic frequencies f₁ and f₂ that are not audible to humans, the output of Equation (1) has the following form:

Y=A(cos(2πf₁t)+cos(2πf₂t))+B(cos(2πf₁t)+cos(2πf₂t)² (2)

The linear term consists of two ultrasonic tones that are not audible. The non-linear term can be further expanded to the following, where N is the non-linear portion of the output:

N=B² cos²(2πf₁t)+B² cos²(2πf₂t)+2B cos(2πf₁t)cos(2πf₂t) (3)

The first two terms are periodic signals in the ultrasonic frequency range with frequencies f₁ and f₂. The third term of N can be evaluated as a combination of single tones, using the trigonometric identity:

2 cos(x) cos(y)=cos(x−y)+cos(x+y) (4)

Then the final form for N is:

N=B² cos²(2πf₁t)+B² cos²(2πf₂t)+B cos[2π(f₁−f₂)t]+B cos[2π(f₁+f₂)t] (5)

The tone with frequency f₁+f₂ is yet another inaudible ultrasonic tone. But the tone with frequency f₁−f₂ can be made to fall into the audible frequency range for appropriate values of f₁ and f₂. The second tone accordingly acts as a frequency translator that shifts the signal down by f₂ Hz. For example, in at least some embodiments ultrasonic tones at 41 kHz and 40 kHz are applied to the input of the external electronic device's 100 microphone, thereby causing the microphone output to have a signal component at 1 kHz. Consequently, even though there is no audible sound provided to the input of the external electronic device's 100 microphone, the output of the microphone contains an audible signal.

In a similar manner, in at least some embodiments one of the tones is replaced with a more complex signal, such as random noise, whether in digital or analog form. Applying this principle, in at least some embodiments jamming is performed using a combination of a tone at 39.5 kHz added to a bandlimited noise signal, such as a signal bandlimited to 33-48 kHz. In this case, the output of the external electronic device's 100 microphone has a 0 to 8.5 kHz noise component. The bandlimited noise signal may be, for example, a bandlimited white noise signal (i.e., a signal where the different frequency components have, on average over a long enough period of time, the same power). Alternatively, the bandlimited noise signal may be, for example, a bandlimited Gaussian noise signal (i.e., a signal where the different frequency components follow a Gaussian distribution). In at least some embodiments, the more complex signal used to replace the second tone may be time-varying over a certain duration instead of a constant over that duration as the tones are; for example, all or portions of the bandlimited noise signal may vary in amplitude over time and/or in response to an input such as ambient noise. While the above example refers to a tone at 39.5 kHz used in conjunction with a bandlimited noise signal spanning 33-48 kHz, different frequencies for the tone and bandlimited signal may be used. For example, in at least some example embodiments the tone may be any signal that falls within the frequency range of the bandlimited signal.

In embodiments that use a noise signal, there are several factors that affect the shape of the noise signal seen by the external electronic device 100:
1. When outputting the signal to the ultrasonic transducer 50, the reconstruction filter in the DAC (digital to analog converter) in the controller 30 may have an effect. If the jamming signal is produced in a digital system with a 96 kHz sample rate, at least some embodiments comprise a low-pass filter in the DAC that attenuates signals above 48 kHz. In practice, frequencies close to 48 kHz, but lower than 48 kHz, are attenuated.
2. In at least some embodiments the transducer 50 has a frequency response that is limited to a narrow band of frequencies, with a peak at the resonant frequency (e.g., 40 kHz). Even if the electrically generated noise signal has a flat frequency response in a particular range, the acoustic signal produced accordingly has a peak at the transducer's 50 resonant frequency.

In at least some example embodiments, the transducer 50 has a resonance frequency of 40 kHz, f₁ is equal to 40 kHz, and f₂ is equal to 39.5 kHz; the resonant peak of the noise acoustic signal is accordingly translated to 500 Hz, which in the audible frequency band of the external electronic device's 100 input. This helps facilitate that the most powerful frequency range of the apparatus 10 is in the frequency range where speech is typically most powerful. The processor 32 generates the 39.5 kHz tone using a 192 element lookup table stored in the flash memory 34 containing one cycle of a sine wave for efficiency.

In at least some other example embodiments that that use the bandlimited noise signal instead of a single tone at f₂, the processor 32 generates the bandlimited noise signal by filtering a sequence of samples generated using a random number function. Before filtering, the sample values are distributed with an approximately uniform distribution between the values −32768 and 32767. A high-pass filter having characteristics such as those depicted in FIG. 2B is used to reduce the power of the signal in lower frequencies. The high-pass filter in at least some embodiments is an FIR filter with coefficients h=[0.029205 −0.237488 0.466583 −0.237488 0.029205]. Using the high-pass filter lowers the volume of audible sounds from the transducer 50.

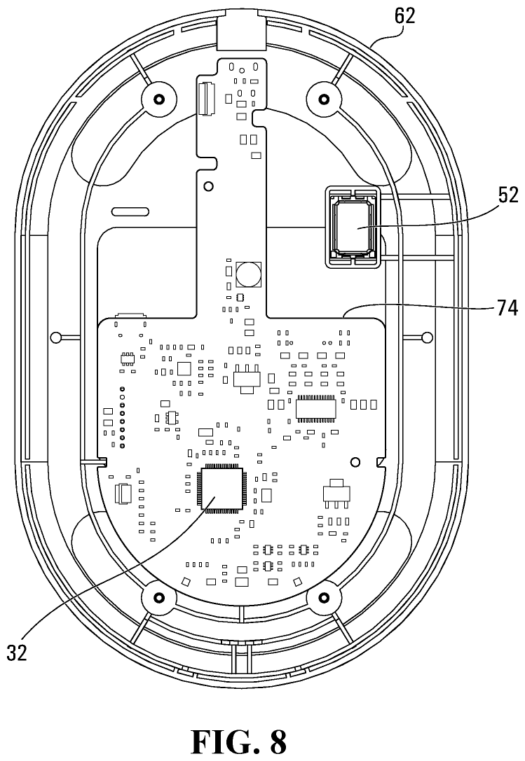

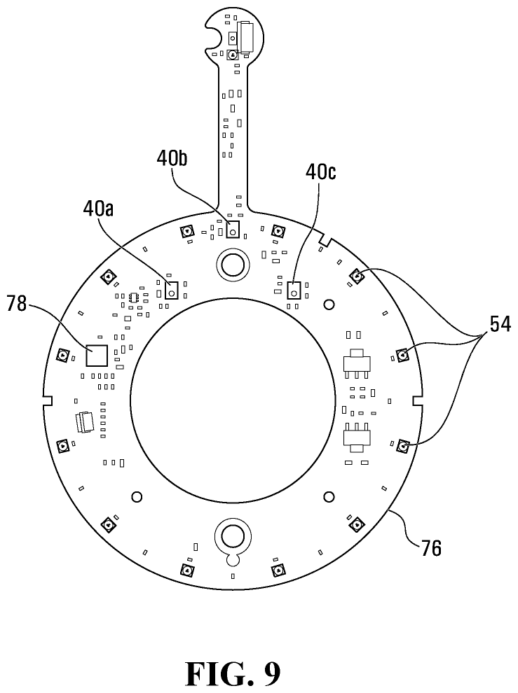

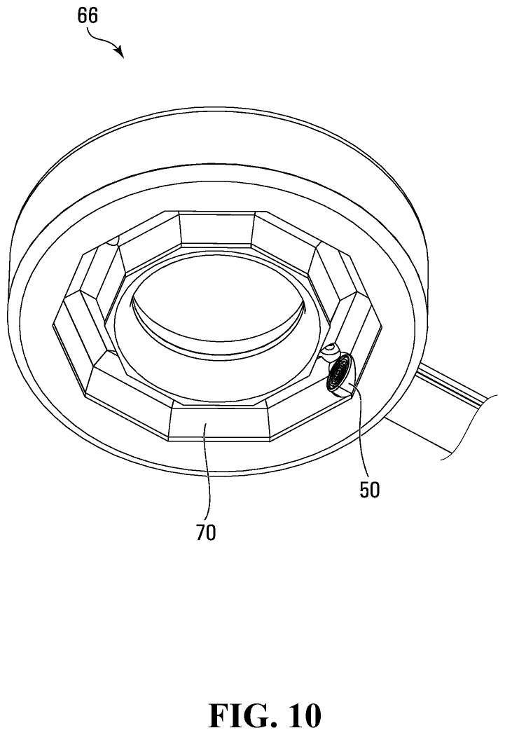

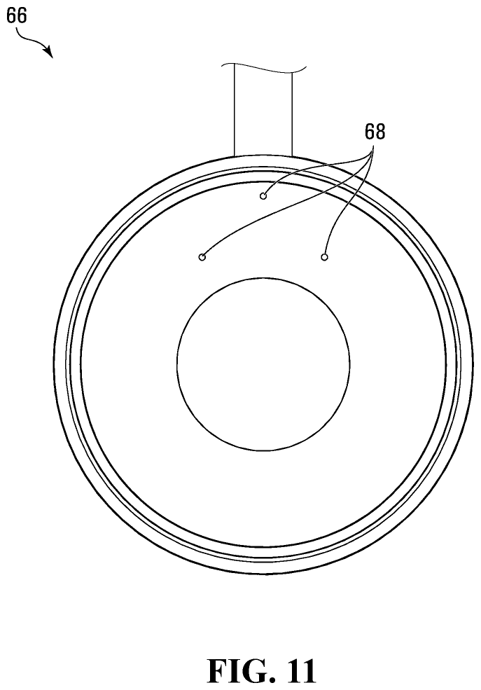

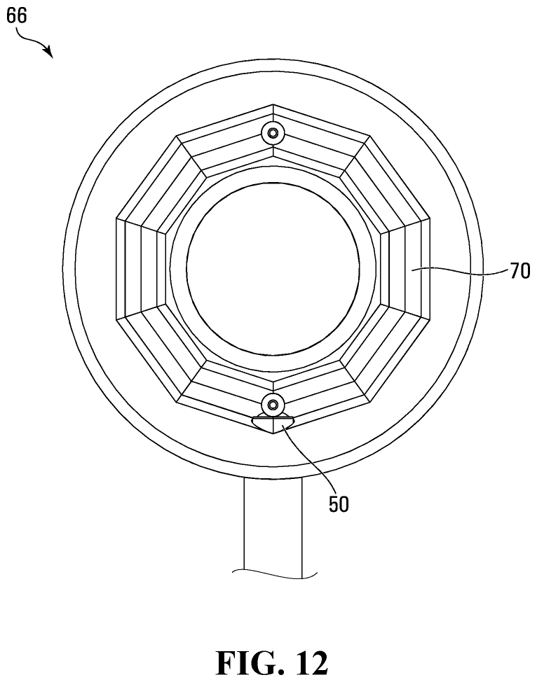

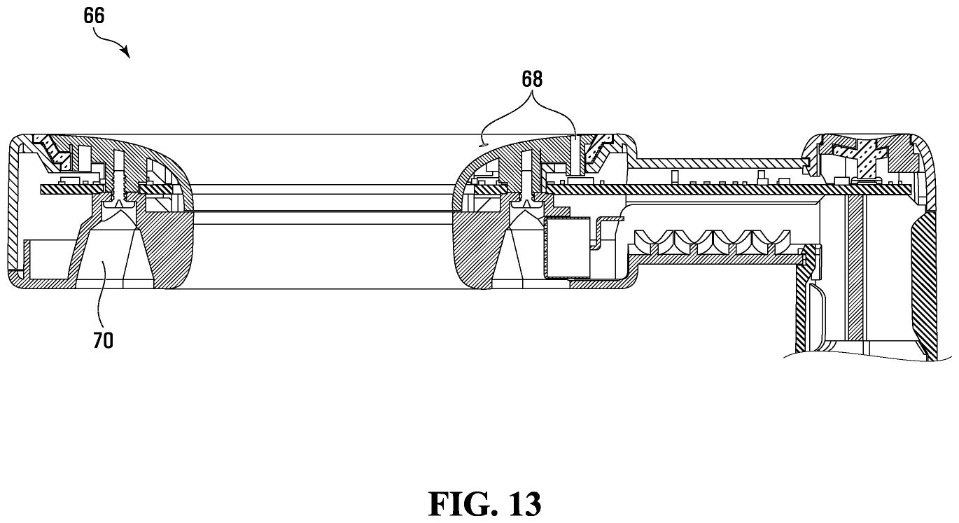

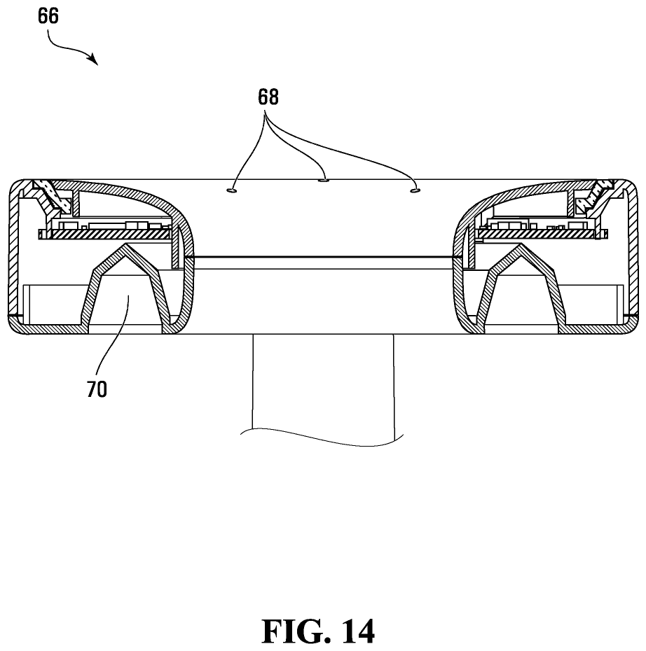

FIGS. 7-14 depict various views of an example embodiment of the apparatus 10. More particularly, FIG. 7 is a perspective view of the apparatus 10; FIG. 8 is a top plan view of a base printed circuit board (PCB) 74 comprising part of a base 62 of the apparatus 10; FIG. 9 is a top plan view of a ring PCB 76 comprising part of a top portion 66 of the apparatus 10; FIG. 10 is a bottom perspective view of the top portion 66 of the apparatus 10; FIG. 11 is a top plan view of the top portion 66 of the apparatus 10; FIG. 12 is a bottom plan view of the top portion 66 of the apparatus 10; FIG. 13 is a sectional view of the top portion 66 of the apparatus 10 taken along line 13-13 of FIG. 7; and FIG. 14 is sectional view of the top portion 66 of the apparatus 10 taken along line 14-14 of FIG. 7. The apparatus 10 is described below with reference to FIGS. 7-14.

The apparatus 10 generally comprises a base 62, an arm 64, and a top portion 66 that acts as a jamming signal emitting portion and that is generally toroidal in shape. More particularly, the depicted top portion 66 has flat, cylindrical sides, a funnel-shaped top surface, and a sound chamber 70 on its underside with the ultrasonic transducer 50 positioned in a side wall of the sound chamber 70. The sound chamber 70 circumscribes the hole in the center of the top portion 66. The base 62 and top portion 66 are positioned generally parallel to each other, with the arm 64 extending between and connecting the base 62 and top portion 66 and generally perpendicular to both. The base 62 comprises a seat 72 in which the external electronic device 100 is placed. In at least some example embodiments, the seat 72 comprises an inductive charger (e.g., a wireless charger that conforms to the Qi standard) to that the external electronic device 100 can be charged while being used in conjunction with the apparatus 10. Jutting out the top of the arm 64 is one of the pushbuttons 44, which is used to manually toggle whether the apparatus 10 is emitting the jamming signal.

The apparatus 10 depicted in FIGS. 7-14 depict a particular example of an apparatus 10 comprising the sound chamber 70 and the ultrasonic transducer 50, where the sound chamber 70 is shaped to direct the ultrasonic jamming signal towards an area for placement of the external electronic device 100. The area for receiving the external electronic device may comprise the base 62 as labelled in FIGS. 7-14 or as also depicted in FIG. 5. Alternatively, the apparatus may be designed so that the external electronic device 100 does not sit directly on any part of the apparatus 10, as depicted in FIGS. 3 and 4.

Three microphone holes 68 extend through a top side of the top portion 66, and as discussed further below in respect of FIG. 9 these microphone holes 68 are respectively located over the first through third microphones 40a-c. The sound chamber 70 on the top portion's 66 underside acts as an echo chamber, with the ultrasonic jamming signal emanated by the ultrasonic transducer 50 reverberating through the sound chamber 70 and being directed downwards to the external electronic device 100 when the apparatus 10 is in use. The sound chamber 70 of the depicted embodiment is rotationally symmetric and comprises ten joined linear segments such that a centerline extending along the centers of the joined segments and parallel to the segments' side walls forms a decagon. As shown in particular in FIG. 14, the sound chamber's 70 cross-section comprises a top portion shaped as or resembling an isosceles triangle, with a base of the isosceles triangle forming a top side of another portion shaped as or resembling an isosceles trapezoid. The sound chamber 70 accordingly has flat sides positioned to direct the ultrasonic jamming signal towards the base 62. In at least the depicted embodiment, the ultrasonic transducer 50 is positioned to emit the ultrasonic jamming signal in a direction parallel to the base 62; the ultrasonic jamming signal hits the flat sides of the sound chamber 70, and the sound chamber 70 directs the jamming signal downwards towards the seat 72.

In other embodiments (not depicted) the sound chamber 70 may have another suitable shape that directs the jamming signal down towards the seat 72 where the external electronic device 100 is when the apparatus 10 is in use. For example, the centerline of the sound chamber 70 may be a smooth curve instead of a segmented one, or a combination of smooth and segmented. Additionally or alternatively, the sound chamber 70 may have a cross-section that appears differently from the one in the figures. For example, the sound chamber 70 may have a parabolic cross-section. In another example embodiment, the top portion 66 is not ring-shaped and the hole extending through the top portion 66 of the apparatus 10 may be replaced with a solid portion that also comprises part of the sound chamber 70. For example, the hole depicted in the top portion 66 may be replaced with a chamber, such as a parabolic chamber, that directs the jamming signal to the seat 72.

Referring in particular to FIG. 8, a top cover of the base 62 is removed and an interior of the base 62 is depicted in which the base PCB 74 is shown lying flat on a bottom panel of the base 62. The base PCB 74 comprises the main processor 32, which generates the jamming signal as described above, and the loudspeaker 52. The main processor 32 controls the loudspeaker 52 to generate sounds such as beeps and confirmation signals.

FIG. 9 depicts a top plan view of the ring PCB 76, which is contained within the top portion 66. One a top surface of the ring PCB 76 are the first through third microphones 40a-c arranged in a triangular pattern corresponding to the positions of the microphone holes 68. Placing the microphones 40a-c and microphone holes 68 on the top side of the apparatus 10 and the ultrasonic transducer 50 on the underside helps to prevent the apparatus 10 from jamming its own microphones 40a-c. A number of the LEDs 54 are circumferentially spaced about the ring PCB 76 and are controlled by a secondary controller in the form of the UI processor 78. Processing for the user interface is delegated to the UI processor 78 so that the main processor 32 on the base PCB 74 can devote relatively more computational power to processing language input received from the microphones 40a-c and generating the jamming signal output by the transducer 50. A ribbon cable (not shown) connects the base and ring PCBs 74, 76 through the arm 64. The transducer 50 is directly connected to the base PCB 74 using a connection outside of the ribbon cable.

As mentioned above, the apparatus 10 when in use may by default broadcast the jamming signal, thereby jamming any external electronic device 100 seated on the base 62. The controller 30 causes the ultrasonic transducer 50 to emit the ultrasonic jamming signal, and in response to physical (e.g., a push of the pushbutton 44 on the arm 64) or audio (e.g. a voice command) input, the controller 30 pauses the jamming signal for a predetermined period of time (e.g., 0.5 seconds) to allow the user to issue a voice command to the external electronic device 100. After expiry of this predetermined period of time, the controller 30 causes the ultrasonic transducer 50 to resume emitting the ultrasonic jamming signal. Other methods are possible in at least some other embodiments. For example, the apparatus 10 may require a physical or audio input to re-activate the jamming signal.

Each of the main and secondary controllers may be any type of controller capable of controlling the transducer 15. For example, one or both of the controllers may comprise a central processing unit (CPU), a graphics processing unit (GPU), a microcontroller, a microprocessor, a processing core, a field-programmable gate array (FPGA), an application-specific integrated circuit (ASIC), or similar. One or both of the controllers may execute instructions stored in the memory storage unit 25. In other examples, one or both of the controllers may be more sophisticated and capable of carrying out other functions as well.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”. A reference to a quantity being “about” or “approximately” a certain value means, unless otherwise indicated, that quantity being within +/−10% of that value.

It should be recognized that features and aspects of the various examples provided above may be combined into further examples that also fall within the scope of the present disclosure.

1. An apparatus comprising:
(a) a sound chamber; and
(b) an ultrasonic transducer configured to emit an ultrasonic jamming signal and positioned to direct the ultrasonic jamming signal to the sound chamber, wherein the sound chamber is shaped to direct the ultrasonic jamming signal towards an area for placement of an external electronic device comprising a microphone.

2. The apparatus of claim 1, wherein an interior of the sound chamber comprises one or more flat sides positioned to direct the ultrasonic jamming signal towards the area for placement of the external electronic device.

3. The apparatus of claim 1, wherein a cross section of the sound chamber comprises a triangular portion on a trapezoidal portion.

4. The apparatus of claim 3, wherein the triangular portion resembles an isosceles triangle and the trapezoidal portion resembles an isosceles trapezoid.

5. The apparatus of claims 1, wherein the ultrasonic transducer is located in a side of the sound chamber.

6. The apparatus of claim 1, further comprising a controller communicatively coupled to the transducer and configured to cause the transducer to emit the jamming signal, wherein the controller is configured to cause the jamming signal to comprise a tone at a first frequency and a bandlimited signal comprising frequency components spanning a frequency range.

7. The apparatus of claim 6, wherein the first frequency is within the frequency range.

8. The apparatus of claim 6, wherein the first frequency is approximately 39.5 kHz.

9. The apparatus of claim 6, wherein the frequency range of the bandlimited signal is from approximately 33 kHz to approximately 48 kHz.

10. The apparatus of claim 6, wherein the bandlimited signal is a bandlimited white noise signal.

11. The apparatus of claim 6, wherein the bandlimited signal is a bandlimited Gaussian noise signal.

12. The apparatus of claim 6, further comprising one or more lights, and wherein the controller comprises:
(a) a main processor configured to cause the transducer to emit the jamming signal; and
(b) a user interface processor configured to control illumination of the one or more lights.

13. The apparatus of claim 1, further comprising:
(a) a base; and
(b) a top portion connected to the base, the top portion comprising the ultrasonic transducer and the sound chamber, wherein the sound chamber is shaped to direct the ultrasonic jamming signal towards the base.

14. The apparatus of claim 13, wherein the sound chamber circumscribes a hole in the top portion.

15. The apparatus of claim 13, wherein the ultrasonic transducer is positioned to emit the ultrasonic jamming signal in a direction parallel to the base.

16. The apparatus of claim 13, wherein the top portion comprises a top side and an underside, wherein the underside comprises the sound chamber and the transducer, and wherein the top side comprises one or more microphones for receiving an audio command.

17. The apparatus of claim 16, further comprising a controller communicatively coupled to the one or more microphones and the transducer, the controller configured to:
(a) cause the ultrasonic transducer to emit the ultrasonic jamming signal;
(b) detect a spoken pause command received via the one or more microphones;
(c) suspend emission of the jamming signal for a predetermined time period in response to the spoken pause command; and
(d) after expiry of the predetermined time period, cause the ultrasonic transducer to resume emitting the ultrasonic jamming signal.

18. The apparatus of claim 13, wherein the base comprises a seat positioned under the top portion, and wherein the seat comprises an inductive charger.

19. An apparatus comprising:
(a) an ultrasonic transducer;
(b) a controller communicatively coupled to the ultrasonic transducer, the controller configured to cause the transducer to emit the jamming signal, wherein the controller is configured to cause the jamming signal to comprise a tone at a first frequency and a bandlimited signal comprising frequency components spanning a frequency range, wherein the first frequency is approximately 39.5 kHz.

20. An apparatus comprising:
(a) an ultrasonic transducer;
(b) a microphone; and
(c) a controller communicatively coupled to the ultrasonic transducer and the microphone, the controller configured to:
(i) cause the ultrasonic transducer to emit the ultrasonic jamming signal;
(ii) detect a spoken pause command received via the one or more microphones;
(iii) suspend emission of the jamming signal for a predetermined time period in response to the spoken pause command; and
(iv) after expiry of the predetermined time period, cause the ultrasonic transducer to resume emitting the ultrasonic jamming signal.
